(19) United States
(12) Patent Application Publication
(10) Pub. No.: US 2022/0404911 A1
(43) Pub. Date: Dec. 22, 2022

(54) DISPLAY APPARATUS

(71) Applicant: Au Optronics Corporation, Hsinchu (TW)

(72) Inventor: Yu-Chin Chu, Hsinchu (TW)

(73) Assignee: Au Optronics Corporation, Hsinchu (TW)

(21) Appl. No.: 17/513,879

(22) Filed: Oct. 28, 2021

(30) Foreign Application Priority Data
Jun. 22, 2021 (TW) 110122714

(51) Int. Cl. G06F 3/01; G02F 1/1333

(52) U.S. Cl. CPC G06F 3/016; G02F 1/13338; G02F 1/133512

(57) ABSTRACT

A display apparatus including a display panel, a sealant, a haptic plate, a vibration source, a buffer layer, and a plurality of supports is provided. The sealant is disposed on the display panel. The haptic plate is disposed on the sealant. The sealant and the haptic plate define an accommodating space. The vibration source is connected to the haptic plate. The vibration source is adapted to vibrate to generate an ultrasonic wave on the haptic plate. The buffer layer is disposed between the haptic plate and the display panel. The buffer layer includes a liquid, and the liquid is disposed within the accommodating space. The supports are disposed between the haptic plate and the display panel. The ultrasonic wave has a node distribution on the haptic plate, and the supports are disposed corresponding to the node distribution.

### CROSS-REFERENCE TO RELATED APPLICATION

This application claims the priority benefit of Taiwanese application no. 110122714, filed on Jun. 22, 2021. The entirety of the above-mentioned patent application is hereby incorporated by reference herein and made a part of this specification.

### BACKGROUND

### Technical Field

The disclosure relates to an optoelectronic apparatus, and particularly relates to a display apparatus.

### Description of Related Art

Among automobile products sold at present, dashboards and control systems are mostly integrated with touch display panels. During driving, if a driver keeps staring at a screen to confirm key positions, it is likely to cause safety concerns. If the touch display panel has haptic feedback which allows the driver to sense a “feedback force” when touching the screen with a finger to provide confirmation of a click position, the driver accordingly does not need to move his line of sight during driving, and driving safety can thus be ensured.

In order to realize the haptic feedback, an ultrasonic vibration technology has been developed, and such technology allows users to have “smooth” and “rough” haptic sensations on the originally cold and rigid touch display panel. Using an ultrasonic wave to vibrate the touch display panel may produce a high-pressure air film between a finger tip and a surface of the touch display panel due to a squeeze film effect. As a result, friction sensed by the finger is reduced. In this way, a smoother haptic sensation of the touch display panel than the haptic sensation before the vibration may be created. If an ultrasonic vibration source is switched back and forth quickly between on and off, the user may sense alternation of low friction and high friction when sliding over the touch display panel with the finger, which may thus create the rough haptic sensation.

### SUMMARY

The disclosure provides a display apparatus with a better performance.

The disclosure provides a display apparatus including a display panel, a sealant, a haptic plate, a vibration source, a buffer layer, and a plurality of supports. The sealant is disposed on the display panel. The haptic plate is disposed on the sealant. The sealant and the haptic plate define an accommodating space. The vibration source is connected to the haptic plate. The vibration source is adapted to vibrate to generate an ultrasonic wave on the haptic plate. The buffer layer is disposed between the haptic plate and the display panel. The buffer layer includes a liquid, and the liquid is disposed within the accommodating space. The supports are disposed between the haptic plate and the display panel. The ultrasonic wave has a node distribution on the haptic plate, and the supports are disposed corresponding to the node distribution.

In an embodiment of the disclosure, the supports and the node distribution are at least partially overlapped.

In an embodiment of the disclosure, the display panel has a light-shielding pattern layer, the light-shielding pattern layer and the node distribution have an intersection area, and the supports and the intersection area are at least partially overlapped.

In an embodiment of the disclosure, a viscosity coefficient of the liquid falls within a range of 0.65 mPa.s to 100 mPa.s.

In an embodiment of the disclosure, a refractive index of the liquid falls within a range of 1.4 to 1.8.

In an embodiment of the disclosure, the display apparatus further includes a housing and an elastic member. The display panel is disposed in the housing. The elastic member is connected to the haptic plate and the housing.

In an embodiment of the disclosure, the haptic plate has an inner surface facing the display panel, an outer surface facing away from the display panel, and a side wall connecting the inner surface and the outer surface, and the elastic member is connected to the side wall of the haptic plate and the housing.

In an embodiment of the disclosure, the haptic plate has an inner surface facing the display panel, an outer surface facing away from the display panel, and a side wall connecting the inner surface and the outer surface, and the elastic member is connected to the inner surface of the haptic plate and the housing.

In an embodiment of the disclosure, the haptic plate has an inner surface facing the display panel, an outer surface facing away from the display panel, and a side wall connecting the inner surface and the outer surface, the elastic member is disposed on the outer surface of the haptic plate, and the elastic member is connected to the housing and the outer surface of the haptic plate.

In an embodiment of the disclosure, the display apparatus further includes a touch sensing structure disposed on the haptic plate.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A to FIG. 1E are schematic cross-sectional views of a manufacturing process of a display apparatus 10 according to an embodiment of the disclosure.

FIG. 2 illustrates a vibration source 400′, a part of a haptic plate 300′, and distribution of a powder P on a part of the haptic plate 300′ according to an embodiment of the disclosure.

FIG. 3 is a schematic top view of a plurality of supports 500 and a haptic plate 300 according to an embodiment of the disclosure.

FIG. 4 is a schematic cross-sectional view of a display apparatus 10A according to an embodiment of the disclosure.

FIG. 5 is a schematic cross-sectional view of a display apparatus 10B according to an embodiment of the disclosure.

FIG. 6 is a schematic cross-sectional view of a display apparatus 10C according to an embodiment of the disclosure.

FIG. 7 is a schematic cross-sectional view of a display apparatus 10D according to an embodiment of the disclosure.

FIG. 8 illustrates a vibration source 400E, a part of a haptic plate 300, and distribution of a powder P on a part of the haptic plate 300 of a display apparatus 10E according to an embodiment of the disclosure.

FIG. 9 is a schematic top view of a plurality of supports 500E and the haptic plate 300 of the display apparatus 10E according to an embodiment of the disclosure.

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

It will be understood that when a component such as a layer, a film, a region, or a substrate is referred to be “on” or “connected to” another component, it may be directly on or connected to the another component, or intermediate components may also exist. Comparatively, when a component is referred to be “directly on” or “directly connected” to another component, other intermediate component does not exit. As used herein, the term “connection” may refer to physical and/or electrical connection. Furthermore, the term “electrical connection” or “coupling” of two components may encompass a case where other components exist between the two components.

The term “about”, “approximate”, or “substantial” used herein includes a stated value and an average value within an acceptable deviation range from a specific value determined by those with ordinary skills in the art while considering the discussed measurement and a specific number of errors associated with the measurement (i.e. limits of a measurement system). For example, the term “about” may represent being within one or more standard deviations of the stated value, or within ±30%, ±20%, ±10%, and ±5%. Moreover, an acceptable deviation range or standard deviation may be selected for the term “about”, “approximate” or “substantial” used herein based on optical properties, etching properties, or other properties without using one standard deviation for all properties.

Unless otherwise defined, all terms (including technical and scientific terms) used herein have the same meaning as commonly understood by one of ordinary skill in the art to which the disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

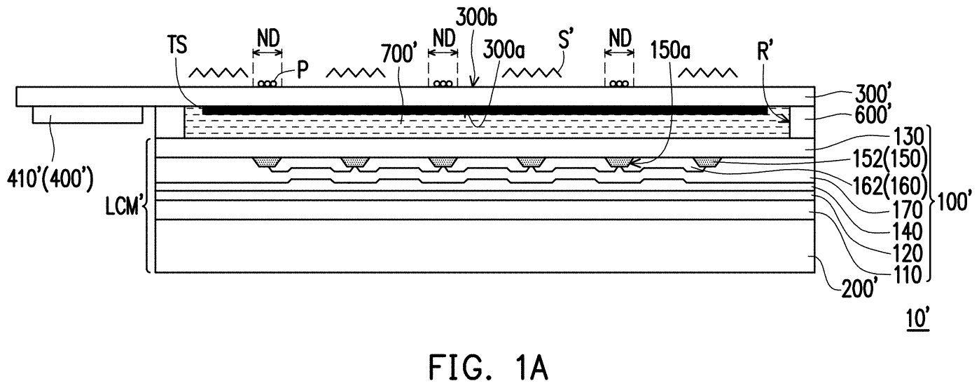

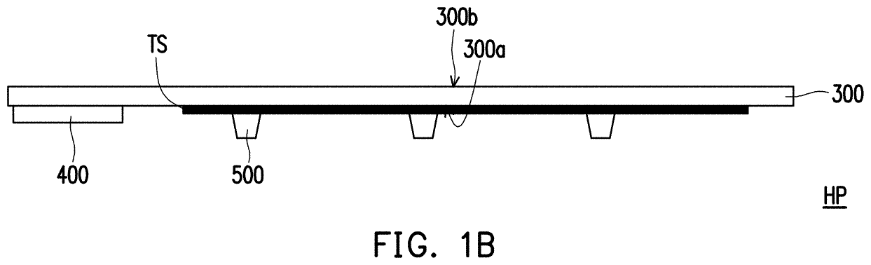

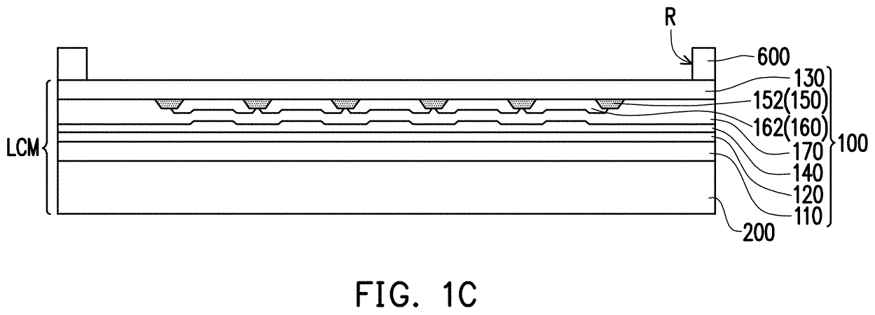

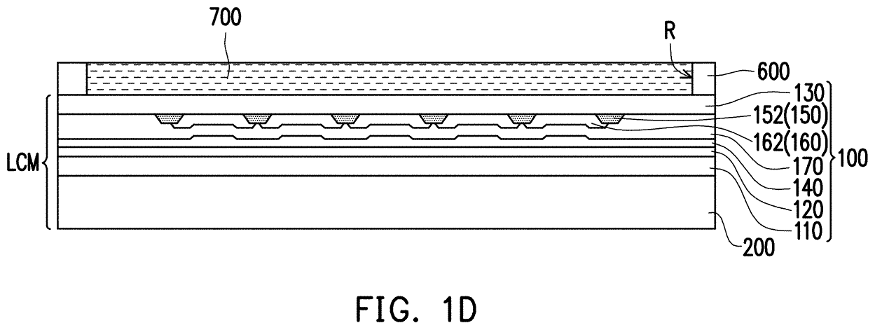

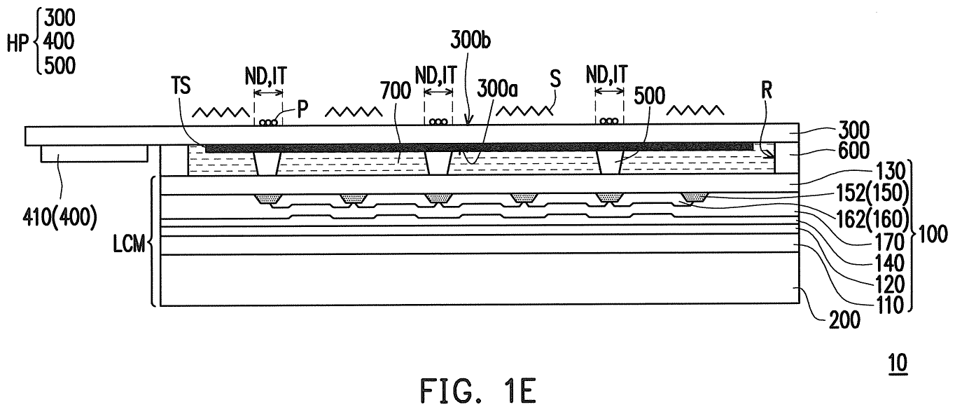

FIG. 1A to FIG. 1E are schematic cross-sectional views of a manufacturing process of a display apparatus 10 according to an embodiment of the disclosure.

Referring to FIG. 1A, first, a display module LCM′ is provided. The display module LCM′ includes a display panel 100′. The display panel 100′ includes a first substrate 110, a pixel array layer 120 disposed on the first substrate 110, a second substrate 130 disposed opposite to the first substrate 110, and a display medium 140 disposed between the first substrate 110 and the second substrate 130.

For example, in the embodiment, the display medium 140 may be a non-self-luminous material (for example, but not limited to: liquid crystal), and the display module LCM′ further includes a backlight module 200′ disposed under the display panel 100′. However, the disclosure is not limited thereto. In other embodiments, the display medium 140 may also be a self-luminous material (for example, but not limited to: an organic electroluminescent layer, a plurality of micro light-emitting diodes, etc.), and the display module LCM′ may also not include the backlight module 200′.

In the embodiment, the display panel 100′ further includes a light-shielding pattern layer 150. The light-shielding pattern layer 150 includes a plurality of longitudinal light-shielding portions (not shown) and a plurality of lateral light-shielding portions 152. The plurality of longitudinal light-shielding portions (not shown) and the plurality of lateral light-shielding portions are intersected to define a plurality of openings 150a, where the plurality of openings 150a are respectively overlapped with a plurality of pixel electrodes (not shown) of the pixel array layer 120.

For example, in the embodiment, the pixel array layer 120 and the light-shielding pattern layer 150 may be selectively disposed on the two opposite substrates (i.e., the first substrate 110 and the second substrate 130), respectively. However, the disclosure is not limited thereto. In other embodiments, the pixel array layer 120 and the light-shielding pattern layer 150 may also be disposed on the same substrate (for example, the first substrate 110).

In the embodiment, the display panel 100′ may further selectively include a color filter layer 160 and a passivation layer 170 covering the color filter layer 160, where the color filter layer 160 includes a plurality of color filter patterns 162, which are respectively overlapped with the plurality of openings 150a of the light-shielding pattern layer 150. For example, in the embodiment, the pixel array layer 120 and the color filter layer 160 may be selectively disposed on the two opposite substrates (i.e., the first substrate 110 and the second substrate 130), respectively. However, the disclosure is not limited thereto. In other embodiments, the pixel array layer 120 and the color filter layer 160 may also be disposed on the same substrate (for example, the first substrate 110).

The display apparatus 10′ further includes a sealant 600′, which is disposed on the display panel 100′, located outside the display panel 100′, and defines an accommodating space R′. The display apparatus 10′ further includes a buffer layer 700′, where the buffer layer 700′ includes a liquid, and the liquid is disposed in the accommodating space R′ defined by the sealant 600′. The display apparatus 10′ further includes a haptic plate 300′ disposed on the sealant 600′, where the buffer layer 700′ is disposed between the haptic plate 300′ and the display panel 100′.

In the embodiment, the liquid of the buffer layer 700′ has a low viscosity coefficient. For example, the viscosity coefficient of the liquid of the buffer layer 700′ may fall within a range of 0.65 mPa.s to 100 mPa.s, but the disclosure is not limited thereto. In the embodiment, a refractive index of the liquid of the buffer layer 700′ is the same as or similar to a refractive index of the haptic plate 300′ and/or a refractive index of the second substrate 130 of the display panel 100′. For example, in the embodiment, a material of the haptic plate 300′ and a material of the second substrate 130 of the display panel 100′ may be glass, a refractive index of glass is about 1.55, and the refractive index of the liquid of the buffer layer 700′ may fall within a range of 1.4 to 1.8, but the disclosure is not limited thereto. In the embodiment, the liquid of the buffer layer 700′ is, for example, oil, but the disclosure is not limited thereto.

The display apparatus 10′ further includes a vibration source 400′, which is connected to the haptic plate 300′, where the vibration source 400′ is adapted to vibrate, so that an ultrasonic wave S′ is formed on the haptic plate 300′. For example, in the embodiment, the vibration source 400′ may include a plurality of vibration elements 410′. The vibration elements 410′ are, for example, piezoelectric ceramics, but the disclosure is not limited thereto.

In the embodiment, the display apparatus 10′ may further selectively include a touch sensing structure TS, where the touch sensing structure TS may be selectively disposed on the haptic plate 300′. For example, in the embodiment, the touch sensing structure TS may be selectively disposed on an inner surface 300a of the haptic plate 300′. However, the disclosure is not limited thereto, and in another embodiment, the touch sensing structure TS may also be disposed on an outer surface 300b of the haptic plate 300′. In addition, the disclosure does not limit the touch sensing structure TS to be must disposed on the haptic plate 300′, and in another embodiment, the touch sensing structure TS may also be disposed in the display panel 100′ and/or outside the display panel 100′ . Furthermore, the disclosure does not limit the display apparatus to must include the touch sensing structure TS, and in another embodiment, the display apparatus may not include the touch sensing structure TS.

Referring to FIG. 1A, a powder P (for example, but not limited to: powdered sugar) is then sprinkled on the haptic plate 300′ of the display apparatus 10′, and the vibration source 400′ starts to vibrate.

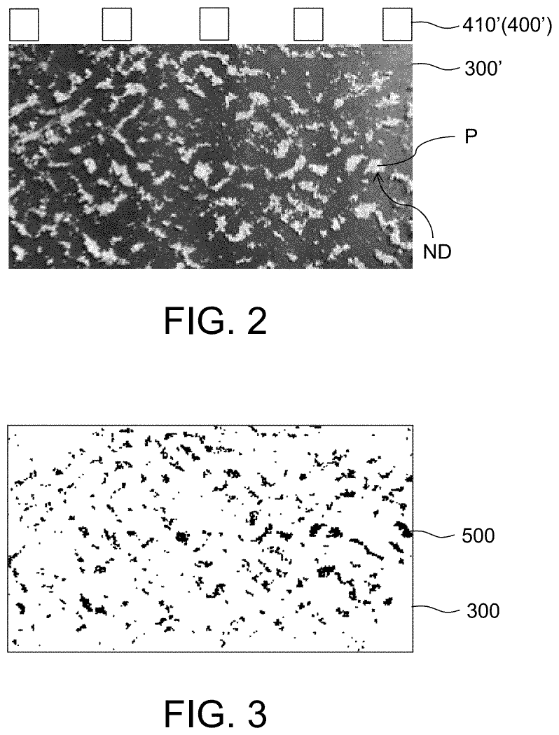

FIG. 2 illustrates the vibration source 400′, a part of the haptic plate 300′, and distribution of the powder P on a part of the haptic plate 300′ according to an embodiment of the disclosure. Referring to FIG. 1A and FIG. 2, after the vibration source 400′ starts to vibrate for a period of time, the powder P may be distributed in a specific position. In detail, the ultrasonic wave S′ caused by the vibration source 400′ may form a stationary wave on the haptic plate 300′, where the stationary wave has a plurality of nodes, and the plurality of nodes form a node distribution ND on the haptic plate 300′. Since an amplitude of the ultrasonic wave S′ on the node distribution ND is substantially zero, the powder P tends to stay at a position that is overlapped with the node distribution ND of the ultrasonic wave S′ to form a powder pattern matched with the node distribution ND of the ultrasonic wave S′.

FIG. 3 is a schematic top view of a plurality of supports 500 and a haptic plate 300 according to an embodiment of the disclosure.

Referring to FIG. 1A, FIG. 1B, FIG. 2 and FIG. 3, a mask (not shown) used for forming a plurality of supports 500 is then made according to the pattern of the powder P matched with the node distribution ND of the ultrasonic wave S′. Then, the plurality of supports 500 are formed on the haptic plate 300 by using the mask.

Referring to FIG. 1B, the vibration source 400 is connected to the haptic plate 300, where the haptic plate 300, the vibration source 400 and the supports 500 may be regarded as a haptic feedback plate HP.

Referring to FIG. 1C, a display module LCM is then provided, and a sealant 600 is formed on the display module LCM, where the sealant 600 defines an accommodating space R.

Referring to FIG. 1D, a buffer layer 700 is then formed in the accommodating space R.

Referring to FIG. 1E, the haptic feedback plate HP is then paired with the display module LCM. After the haptic feedback plate HP and the display module LCM are paired, the plurality of supports 500 are disposed between the haptic plate 300 and a display panel 100. At this point, fabrication of the display apparatus 10 of the embodiment is completed.

Referring to FIG. 1A and FIG. 1E, the display apparatus 10 of the embodiment is similar to the aforementioned display apparatus 10′ with the design of the mask used for forming the supports 500. To be specific, the display module LCM and the display panel 100 and the backlight module 200 of the display apparatus 10 of the embodiment are substantially the same as the display module LCM′ and the display panel 100′ and the backlight module 200′ of the aforementioned display apparatus 10′. The sealant 600 of the display apparatus 10 of the embodiment and the accommodating space R defined by the sealant 600 are substantially the same as the sealant 600′ and the accommodating space R′ defined by the sealant 600′ of the aforementioned display apparatus 10′. The buffer layer 700 of the display apparatus 10 of the embodiment is substantially the same as the buffer layer 700′ of the aforementioned display apparatus 10′. The haptic plate 300 of the display apparatus 10 of the embodiment is substantially the same as the haptic plate 300′ of the aforementioned display apparatus 10′. The vibration source 400′ and the vibration elements 410 thereof of the display apparatus 10 of the embodiment are substantially the same as the vibration source 400 and the vibration elements 410′ thereof of the aforementioned display apparatus 10′, and the node distribution ND of the ultrasonic wave S caused by the vibration source 400 of the display apparatus 10 of the embodiment on the haptic plate 300 is substantially the same as the node distribution ND of the ultrasonic wave S′ caused by the vibration source 400′ of the aforementioned display apparatus 10′ on the haptic plate 300′. The same or similar parts of the display apparatus 10 of the embodiment and the aforementioned display apparatus 10 may be learned by referring to the foregoing description, which will not be repeated.

A difference between the display apparatus 10 of the embodiment and the aforementioned display apparatus 10′ is that the display apparatus 10 of the embodiment further includes the plurality of supports 500 for maintaining a space between the haptic plate 300 and the display panel 100. Referring to FIG. 1E, the ultrasonic wave S caused by the vibration source 400 forms a node distribution ND on the haptic plate 300, and the plurality of supports 500 and the node distribution ND of the ultrasonic wave S are at least partially overlapped. In the embodiment, the light-shielding pattern layer 150 and the node distribution ND of the ultrasonic wave S have an intersection area IT, the light-shielding pattern layer 150 and the node distribution ND are intersected on the intersection area IT, and the supports 500 and the light-shielding pattern layer 150 and intersection area IT of the light-shielding pattern layer 150 and the node distribution ND are at least partially overlapped.

It should be noted that since the buffer layer 700 is disposed between the haptic plate 300 and the display panel 100, and the buffer layer 700 includes liquid, when the ultrasonic wave is formed on the surface of the haptic plate 300 along with the vibration of the vibration source 400, the ultrasonic wave S is not easy to be absorbed, and the display apparatus 10 has a good haptic feedback effect. At the same time, since interface reflection of the buffer layer 700, the haptic plate 300 and/or the display panel 100 is less, the display apparatus 10 may further have a good display effect while having the good haptic feedback effect.

In addition, in the embodiment, when a finger (not shown) of the user presses the haptic plate 300, the supports 500 may prevent the haptic plate 300 from bending down excessively and excessively squeezing the buffer layer 700, so that a shape of the buffer layer 700 will not be excessively changed to affect the display effect of the display apparatus 10.

Moreover, in the embodiment, since positions of the supports 500 and the node distribution ND are overlapped, the arrangement of the supports 500 does not excessively affect the vibration of the haptic plate 300, and the display and haptic feedback effect of the display apparatus 10 are even better.

It should be noticed that reference numbers of the components and a part of contents of the aforementioned embodiment are also used in the following embodiment, where the same reference numbers denote the same or like components, and descriptions of the same technical contents are omitted. The aforementioned embodiment may be referred for descriptions of the omitted parts, and detailed descriptions thereof are not repeated in the following embodiment.

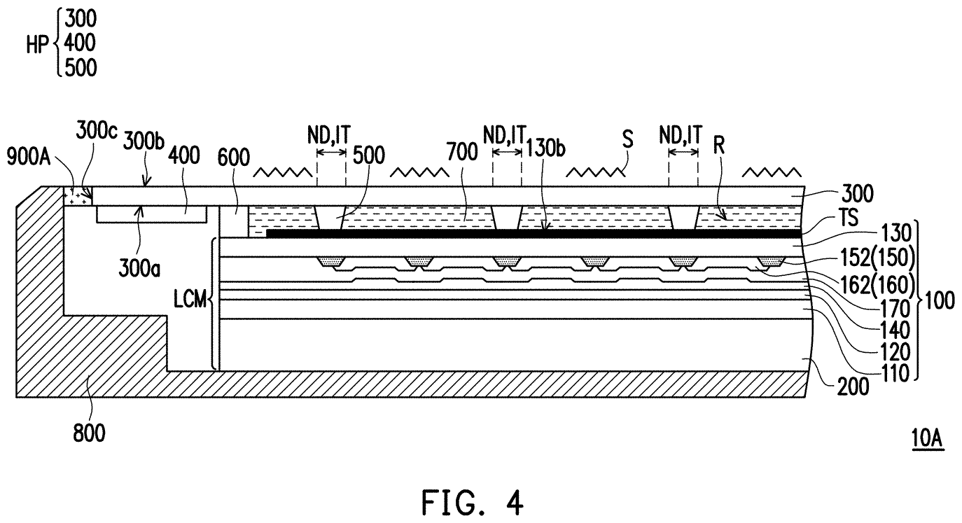

FIG. 4 is a schematic cross-sectional view of a display apparatus 10A according to an embodiment of the disclosure. The display apparatus 10A of FIG. 4 is similar to the display apparatus 10 of FIG. 1E, and a difference there between is that the display apparatus 10A of FIG. 4 further includes a housing 800 and an elastic member 900A, where the display panel 100 is disposed in the housing 800, and the elastic member 900A is connected to the haptic plate 300 and the housing 800. The elastic member 900A may separate the vibration on the haptic plate 300 from a peripheral mechanism (for example, a frame body) to prevent the vibration from being absorbed by the peripheral mechanism.

Referring to FIG. 4, the haptic plate 300 has an inner surface 300a facing the display panel 100, an outer surface 300b facing away from the display panel 100, and a side wall 300c connecting the inner surface 300a and the outer surface 300b. In the embodiment, the elastic member 900A may be selectively connected to the side wall 300c of the haptic plate 300 and the housing 800, but the disclosure is not limited thereto. In the embodiment, the elastic member 900A is, for example, a rubber gasket or foam, but the disclosure is not limited thereto.

In addition, another difference between the display apparatus 10A of FIG. 4 and the display apparatus 10 of FIG. 1E is that the touch sensing structure TS of the display apparatus 10A of FIG. 4 may be disposed on the display panel 100. For example, in the embodiment, the touch sensing structure TS may be disposed on an outer surface 130b of the second substrate 130 of the display panel 100 facing the haptic plate 300. However, the disclosure is not limited thereto, and in other embodiments, the touch sensing structure TS may also be disposed in the display panel 100 (i.e., between the first substrate 110 and the second substrate 130 of the display panel 100).

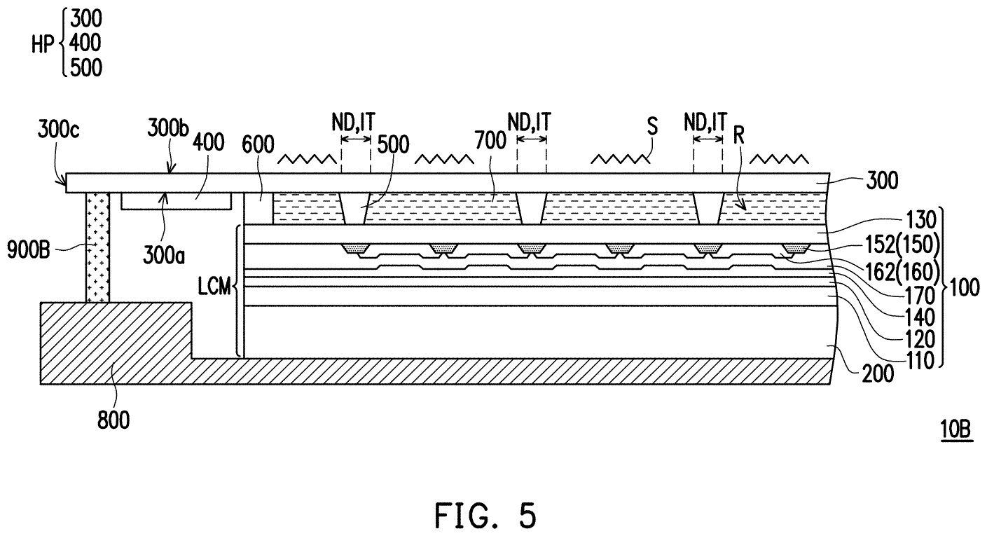

FIG. 5 is a schematic cross-sectional view of a display apparatus 10B according to an embodiment of the disclosure. The display apparatus 10B of FIG. 5 is similar to the display apparatus 10A of FIG. 4, and a difference there between is that positions of the elastic members 900A and 900B are different. Referring to FIG. 5, to be specific, in the embodiment, the elastic member 900B may be selectively connected to the inner surface 300a of the haptic plate 300 and the housing 800. In addition, another difference between the display apparatus 10B of FIG. 5 and the display apparatus 10A of FIG. 4 is that the display apparatus 10B of FIG. 5 may not include the touch sensing structure TS.

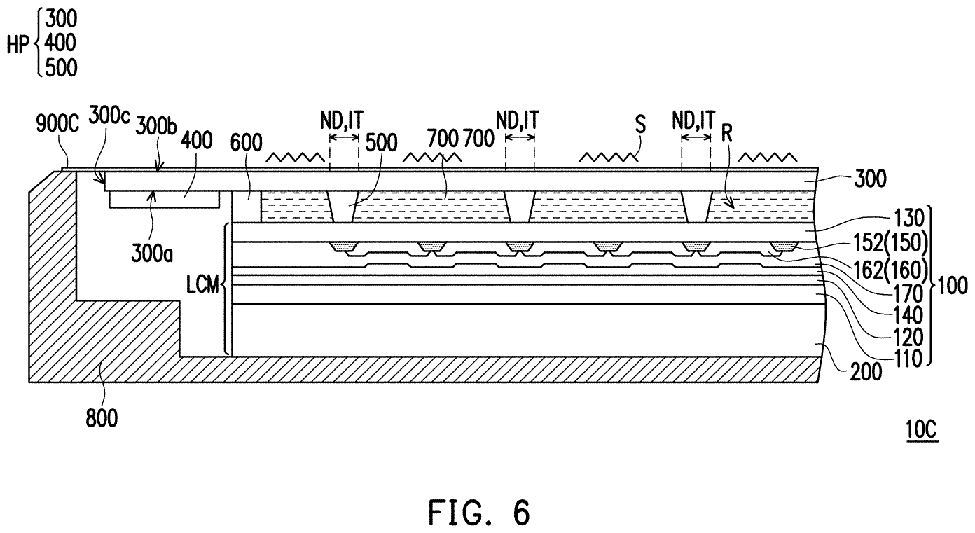

FIG. 6 is a schematic cross-sectional view of a display apparatus 10C according to an embodiment of the disclosure. The display apparatus 10C of FIG. 6 is similar to the display apparatus 10A of FIG. 4, and a difference there between is that positions of the elastic members 900A and 900C are different. Referring to FIG. 6, to be specific, in the embodiment, the elastic member 900C is disposed on the outer surface 300b of the haptic plate 300 and is connected to the housing 800 and the outer surface 300b of the haptic plate 300. In addition, in the embodiment, the elastic member 900C may be an elastic plastic film extending to the outside of the haptic plate 300. In addition, another difference between the display apparatus 10C of FIG. 6 and the display apparatus 10A of FIG. 4 is that the display apparatus 10C of FIG. 6 may not include the touch sensing structure TS.

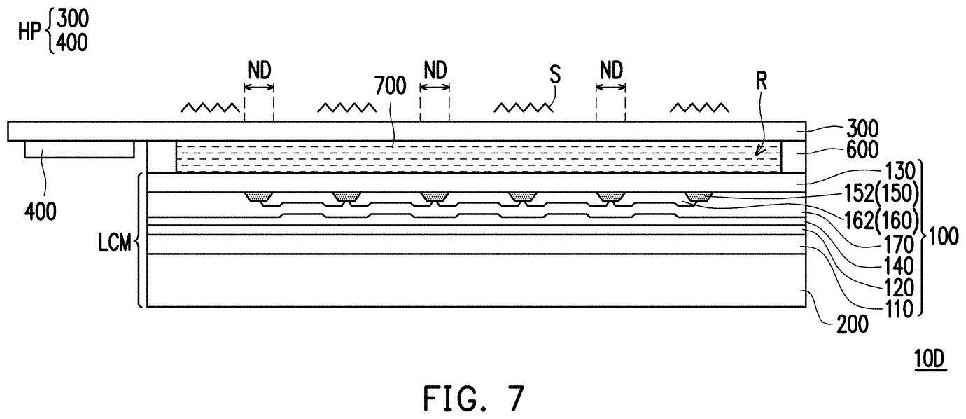

FIG. 7 is a schematic cross-sectional view of a display apparatus 10D according to an embodiment of the disclosure. The display apparatus 10D of FIG. 7 is similar to the display apparatus 10 of FIG. 1E. and a difference there between is that the display apparatus 10D of FIG. 7 may not include the supports 500 of the display apparatus 10 of FIG. 1E. In addition, another difference between the display apparatus 10D of FIG. 7 and the display apparatus 10 of FIG. 1E is that the display apparatus 10D of FIG. 7 may not include the touch sensing structure TS.

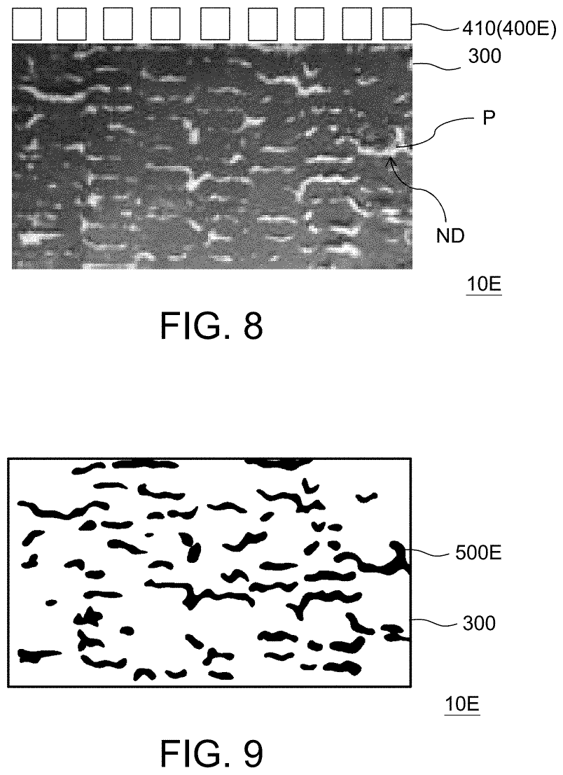

FIG. 8 illustrates the vibration source 400E, a part of the haptic plate 300, and distribution of the powder P on a part of the haptic plate 300 of the display apparatus 10E according to an embodiment of the disclosure. FIG. 9 is a schematic top view of the plurality of supports 500E and the haptic plate 300 of the display apparatus 10E according to an embodiment of the disclosure.

Referring to FIG. 2 and FIG. 8, a difference between the vibration source 400E of FIG. 8 and the vibration source 400′ of FIG. 2 lies in: the arrangement of the multiple vibration elements 410 of the vibration source 400E of FIG. 8 is denser than the arrangement of the multiple vibration elements 410′ of the vibration source 400′ of FIG. 2, and the distribution of the powder P on the haptic plate 300 of FIG. 8 is more regular than the distribution of the powder P on the haptic plate 300 of FIG. 2.

Referring to FIG. 3 and FIG. 9, the supports 500E of FIG. 9 are similar to the supports 500 of FIG. 3, the supports 500 of FIG. 3 are fabricated on the haptic plate 300 according to the distribution of the powder P of FIG. 2 (i.e. the node distribution ND), and the supports 500E of FIG. 9 are fabricated on the haptic plate 300 according to the distribution of the powder P that is substantially the same as that of FIG. 8. A difference between the supports 500E of FIG. 9 and the supports 500 of FIG. 3 is that the supports 500 of FIG. 3 are irregularly distributed, while the supports 500E of FIG. 9 are substantially regularly distributed.

1. A display apparatus, comprising:
a display panel;
a sealant, disposed on the display panel;
a haptic plate, disposed on the sealant, wherein the sealant and the haptic plate define an accommodating space;
a vibration source, connected to the haptic plate, wherein the vibration source is adapted to vibrate to generate an ultrasonic wave on the haptic plate;
a buffer layer, disposed between the haptic plate and the display panel, wherein the buffer layer comprises a liquid, and the liquid is disposed within the accommodating space; and
a plurality of supports, disposed between the haptic plate and the display panel, wherein the ultrasonic wave caused by the vibration source forms a stationary wave on the haptic plate, the stationary wave has a plurality of nodes, the plurality of nodes form the node distribution on the haptic plate, and the supports are disposed corresponding to the node distribution.

2. The display apparatus as claimed in claim 1, wherein the supports and the node distribution are at least partially overlapped.

3. The display apparatus as claimed in claim 2, wherein the display panel has a light-shielding pattern layer, the light-shielding pattern layer and the node distribution have an intersection area, and the supports and the intersection area are at least partially overlapped.

4. The display apparatus as claimed in claim 1, wherein a viscosity coefficient of the liquid falls within a range of 0.65 mPa.s to 100 mPa.s.

5. The display apparatus as claimed in claim 1, wherein a refractive index of the liquid falls within a range of 1.4 to 1.8.

6. The display apparatus as claimed in claim 1, further comprising:
a housing, wherein the display panel is disposed in the housing; and
an elastic member, connected to the haptic plate and the housing.

7. The display apparatus as claimed in claim 6, wherein the haptic plate has an inner surface facing the display panel, an outer surface facing away from the display panel, and a side wall connecting the inner surface and the outer surface, and the elastic member is connected to the side wall of the haptic plate and the housing.

8. The display apparatus as claimed in claim 6, wherein the haptic plate has an inner surface facing the display panel, an outer surface facing away from the display panel, and a side wall connecting the inner surface and the outer surface, and the elastic member is connected to the inner surface of the haptic plate and the housing.

9. The display apparatus as claimed in claim 6, wherein the haptic plate has an inner surface facing the display panel, an outer surface facing away from the display panel, and a side wall connecting the inner surface and the outer surface, the elastic member is disposed on the outer surface of the haptic plate, and the elastic member is connected to the housing and the outer surface of the haptic plate.

10. The display apparatus as claimed in claim 1, further comprising:
a touch sensing structure, disposed on the haptic plate.
